(19) United States
(12) Patent Application Publication
(10) Pub. No.: US 2018/0116462 A1
(43) Pub. Date: May 3, 2018

(54) METHOD AND APPARATUS FOR STYLIZING FOODSTUFF

(71) Applicant: National Presto Industries, Inc., Eau Claire, WI (US)

(72) Inventor: Michael R. Berge, Eau Claire, WI (US)

(21) Appl. No.: 15/336,416

(22) Filed: Oct. 27, 2016

(51) Int. Cl. A47J 43/00; A23L 5/10

(52) U.S. Cl. CPC A47J 43/00; A23V 2002/00; A23L 5/10

(57) ABSTRACT

A foodstuff stylizing member and related methods for stylizing foodstuff through the use of heat-resistant materials. The foodstuff stylizing member can include a perimeter wall, a side wall, an upper surface and a lower surface. Either the upper or lower surface can be placed directly onto a heated cooking surface, whereby an uncooked food item can be placed onto or poured over at least a portion of the foodstuff stylizing member to form a visual element on a cooked food item.

### TECHNICAL FIELD

The present invention relates to the stylizing of foodstuff. More specifically, the present relates to the formation of designs on foodstuff through the intentional positioning of stylizing implement during cooking.

### BACKGROUND

In the culinary field, the aesthetic appeal of food items is of growing emphasis relative to the elements of taste and texture. As such, there is the emerging trend towards cooking foods with attractive and entertaining designs. Stylizing food through shaping, coloring and texturing among other things can be accomplished in a variety of ways such as adding food dyes, using cut-outs or molds, or by layering. This is particularly useful when cooking items that having defined surfaces can be used as a canvas for expressive or interesting designs. For instance, some bake products, such as for example, pancakes and waffles are formed from poured batters and as they are cooked, develop visible surfaces that can provide an easily viewable and attractive canvas for stylizing. In addition, bread can be cooked for example in preparing grilled cheese sandwiches or French toast wherein the viewable bread surface also makes an attractive canvas. Finally, certain cuts of meat such as, for example, steaks and pork chops are also typically cut so as to have easily viewable surface

In the case of pourable batters such as used in pancakes, children and adults alike enjoy designing pancakes and other bakery items with entertaining designs such as a cartoon mouse or smiley faces. Generally, the designs can be attempted by pouring the batter in a desired shape or through the use of a mold or “cookie cutter.” While pouring or molding the batter into a desired shape can provide a basic perimeter shape for a pancake, this does not contribute anything to the appearance of the cooked portions; i.e., the top and bottom surfaces of the cooked item. Accordingly, it would be beneficial to provide a mechanism that serves as an effective means of stylizing viewable surface of food products.

### SUMMARY

The present invention addresses these issues by providing a stylizing member formed of a heat resistant polymer that is capable of absorbing heat with minimal conduction, while still remaining solid when exposed to hot cooking surfaces, thus having the ability to emblemize or stylize food in the shape of a polymer cutout. As a result of being positioned between the hot cooking surface and the food, the stylizing member can effectively eliminate surface browning on the food whereby a distinct color contrast is visually identifiable between the portion of the food in contact with the cooking surface and the portion of the food that is separated from the cooking surface by the styling member. Based on the type of food, for example, products formed from a pourable batter, the resulting cooked product can be left with an indent where it was poured over the stylizing member in addition to a difference in color shading. The stylizing member can be cut or stamped from sheets or molded to resemble a specific design, logo, and/or shape. Generally, the heat resistant polymer is chosen of a material suited for food contact and that possesses a melting point high enough to resist melting when placed directly on a griddle or pan and cooked at conventional baking temperatures. The stylizing member is capable of being reused and can be cleaned or sanitized for reuse by simple hand washing or through placement in a dishwasher. In some embodiment, the heat resistant material can be selected of materials such as, for example, silicone rubber and PTFE.

One of the objects of the present invention is to provide a styling member that is capable of emblemizing food stuff by minimizing direct heat application to a surface of the food stuff such that a difference in color, i.e. reduction in surface browning, is visibly observable. Specifically, the stylizing member can comprise a heat resistant material, for example, silicone rubber or PTFE, that is cut, stamped, molded or otherwise formed into various shapes and designs. The stylizing member can comprise shapes such as circles, squares or triangles, various patterns including, logos and emblems. By placing the stylizing member directly on a cooking surface and then placing or pouring (in the case of a batter such as, for example, pancakes, the foodstuff over at least a portion of stylizing member, the cutout minimizes the flow of heat to food surfaces in contact with the stylizing member resulting in a color difference as compared to food surfaces in direct contact with the cooking surface. In certain embodiments, the stylizing member can be formed to have a pronounced thickness or width that results in the formation of a more pronounced indent in the food surface in addition to a color difference. As such, the stylizing member can provide an observable surface appearance on a foodstuff that includes visual elements related to both differences in depth and coloration.

Another object of the present invention is to provide an improved method of stylizing foodstuff that includes the use of a stylizing member in order to indent and/or or vary color on a food surface so as to depict a visual design. Specifically the method can comprise forming a stylizing member from a suitable high temperature polymer so as to have a specific shape or figure. In some embodiments, the stylizing member can be formed by cutting or molding the stylizing member from the high temperature polymer. The method can further comprise placing the stylizing member directly on a cooking surface, for example, a griddle surface, a glass range surface, a frying pan, a cookie sheet and the like, whereby a foodstuff is placed at least partially on top of the stylizing member. The method can further comprise minimizing heat transfer to a selected surface of the foodstuff, such that visible difference, i.e., browning is visually identifiable between the portion of the foodstuff in direct contact with the cooking surface and the portion of the foodstuff separated from the cooking surface by the stylizing member. In some embodiments, the method can further comprise forming an indent in the selected surface of the foodstuff, where the foodstuff is separated from the cooking surface by its placement on the stylizing member. The method can further comprise removing the foodstuff from the stylizing member and cooking surface whereby a stylized color design and/or imprint is visibly identifiable on the selected surface of the foodstuff.

In another specific embodiment, the present invention can be directed to methods for stylizing pancakes. Generally, the method can comprise placing a stylizing member directly on a cooking surface, for example, a griddle surface, a glass range surface or a frying pan. The method can further comprise pouring a pancake batter directly over a top surface of the stylizing member such that as the pancake batter spreads, at least a portion, preferably a center portion, of the poured batter covers the stylizing member. The method further comprises minimizing heat transfer to the portion of the poured batter that is covering the stylizing member such that as the poured batter is cooked, a color difference, i.e., level of browning, is visually identifiable between the portion of the poured batter in direct contact with the cooking surface and the portion of the poured batter separated from the cooking surface by the stylizing member. In some embodiments, the method can further comprise forming an indent in the portion of the poured batter that is separated from the cooking surface by its placement on the stylizing member. The method can further comprise flipping the poured batter to cook a second side of the poured batter, wherein at least a portion of the second side is positioned on top of the stylizing member so as to impart color differences and/or imprints to the second side. The method can further comprise removing a cooked pancake from the cooking surface whereby one or more sides of the cooked pancake includes visible color differences and/or imprints that correspond to a shape of the stylizing member.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1a is a top view of a stylizing member according to a representative embodiment of the present invention.

FIG. 1b is a top view of a stylizing member according to a representative embodiment of the present invention.

FIG. 1c is a top view of a stylizing member according to a representative embodiment of the present invention.

FIG. 1d is a top view of stylizing member according to a representative embodiment of the present invention.

FIG. 2 is a cross-sectional view of the stylizing member of FIG. 1a taken at line 2-2 of FIG. 1a.

FIG. 3a is a top view of a stylizing member according to a representative embodiment of the present invention.

FIG. 3b is a top view of a stylizing member according to a representative embodiment of the present invention.

FIG. 3c is a top view of a stylizing member according to a representative embodiment of the present invention.

FIG. 4 is a perspective view of the stylizing member of FIG. 3b position on a cooking surface as a pourable batter is poured over the stylizing member according to an embodiment of the present invention.

FIG. 5 is a perspective view of the pourable batter covering the stylizing member according to an embodiment of the present invention.

FIG. 6 is a perspective view of the stylizing member being removed from a cooked surface of a pancake while leaving a visual element displayed on the cooked surface according to an embodiment of the present invention.

FIG. 7a is a top view of a cooked pancake including a visual element formed with the stylizing member of FIG. 3a.

FIG. 7b is a top view of a cooked pancake including a visual element formed with the stylizing member of FIG. 3b.

FIG. 7c is a top view of a cooked pancake including a visual element formed with the stylizing member of FIG. 3c.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

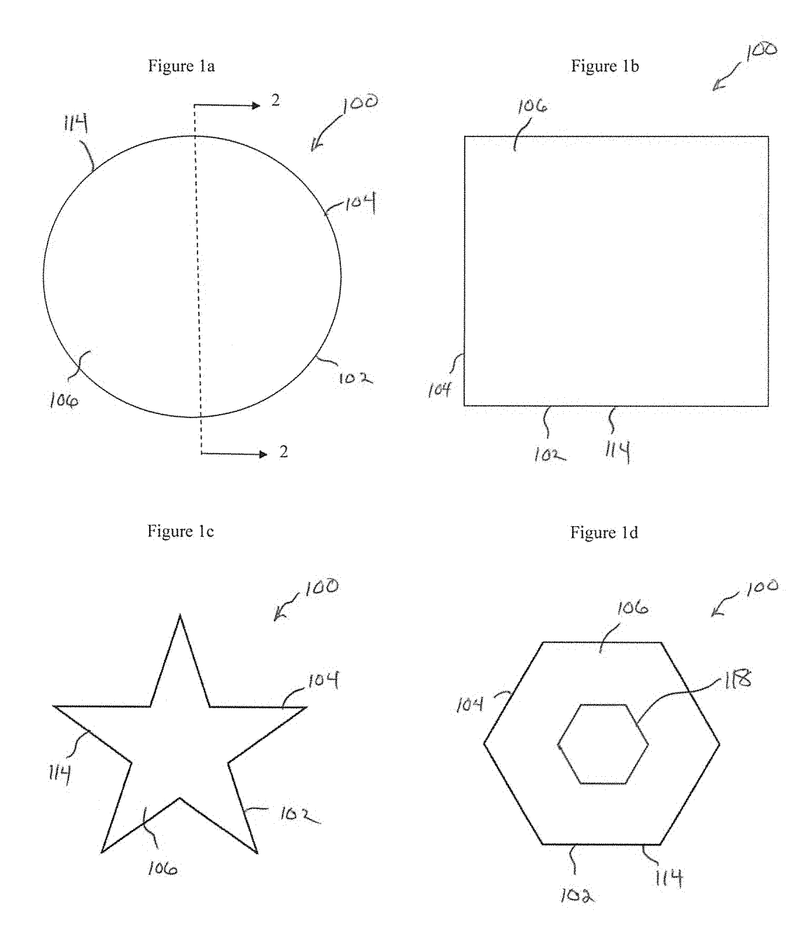

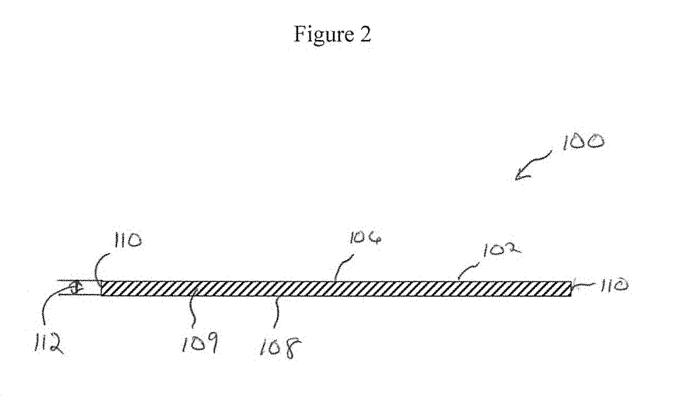

As illustrated generally in FIGS. 1, 1b, 1c, 1d, 2, 3a, 3b and 3c, an embodiment of a stylizing member 100 of the present invention can be provided in wide variety of shapes and appearances. Generally, stylizing member 100 includes a body 102 defined by a perimeter wall 104, an upper surface 106 and a lower surface 108. As seen in FIG. 2, the perimeter wall 104 is defined by a side wall 110 having a wall thickness 112 defined between the upper surface 106 and the lower surface 108. The body 102 can be formed from a heat resistant material 109 that is satisfactory for food contact. In some instances, the heat resistant material 109 can comprise one or more suitable polymers capable of resisting melting at elevated temperatures such as, for example, silicon rubber, PTFE and the like. In some embodiments, the heat resistant material 109 can comprise a heat resistant fabric that has been coated with a non-stick material. For example, fiberglass and organic fabric materials can be coated with a non-stick PTFE coating. Generally, heat resistant material 109 should have a melting point exceeding at least 500° F.

According to another embodiment of the present invention, the heat-resistant material can include, metal, silicon, or an organic polymer such as PTFE and combinations thereof. The invention can also comprise of materials compatible with machine washing and sanitation for reuse.

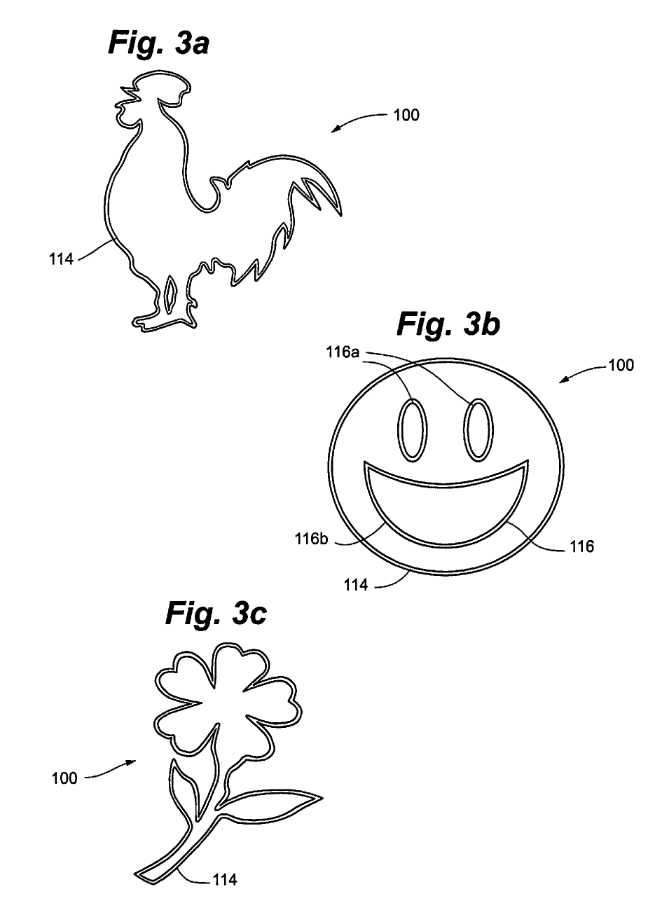

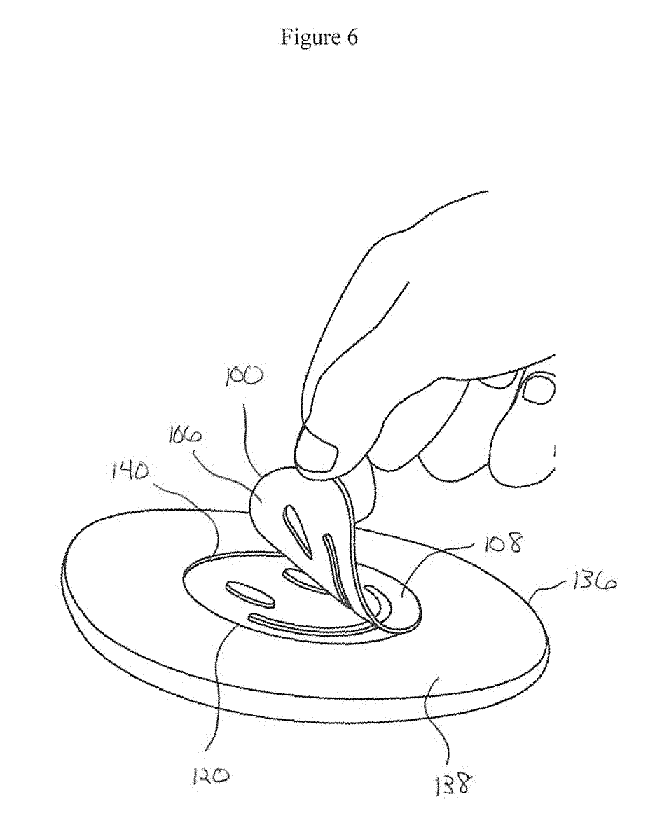

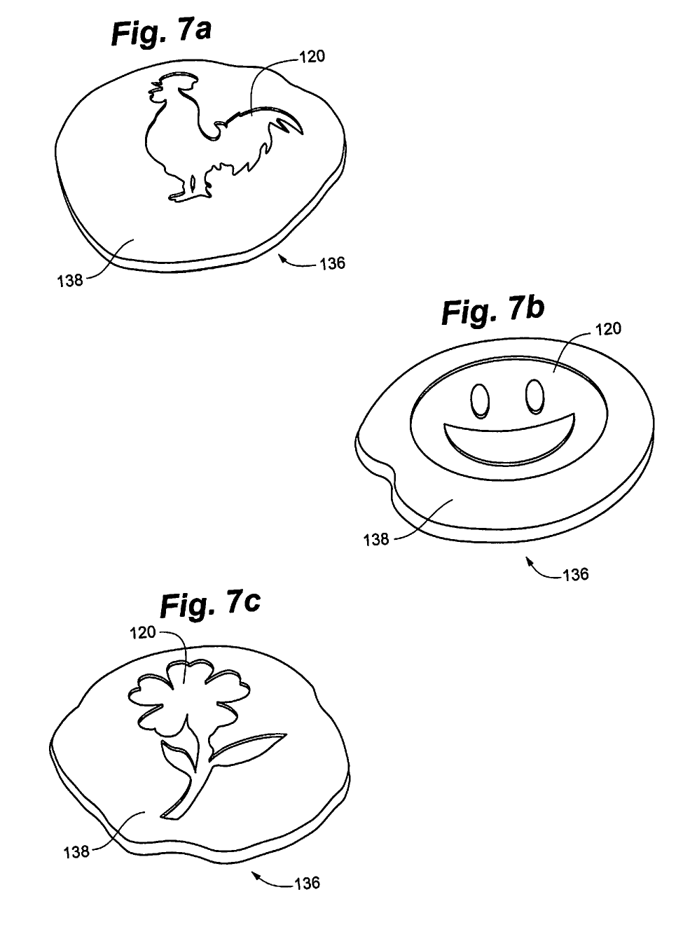

Body 102, and more specifically, the perimeter wall 104 can define various body shapes 114, such as, for example a circle as seen in FIG. 1a, a rectangle as seen in FIG. 1b, a star as seen in FIG. 1c, a hexagon as seen in FIG. 1d, a rooster as seen in FIG. 3a, a smiley face as seen in FIG. 3b and a flower as seen in FIG. 3c. The illustrated body shapes 114 are merely representative of potential shapes and could further include an almost endless variety of shapes such as, for example, letters and words, logos, cartoon characters and the like. In certain embodiments, the body 102 can include various apertures 116 defined between the upper surface 106 and lower surface 108, for example, including eye apertures 116a or mouth apertures 116b as illustrated within FIG. 3b. The aperture 116 can further assist in defining simple shapes, figures logos or designs. In some embodiments, the body 102 can comprise inserts 118, for example, metal inserts possessing a heat capacity that differs from that of the heat resistant material 109. Inserts 118 conducting heat at a different rate than the remainder of the body 102 can provide additional color differences during cooking. In combination, the body shape 114 and/or apertures 116 and/or insert 118 can collectively define a visual element 120 as seen in FIGS. 6, 7a, 7b and 7c. Visual element 120 can comprise a variety of logos characters and other desirable visual features, for example, licensed properties such as professional sports logos, cartoon characters, and other similar visual designs.

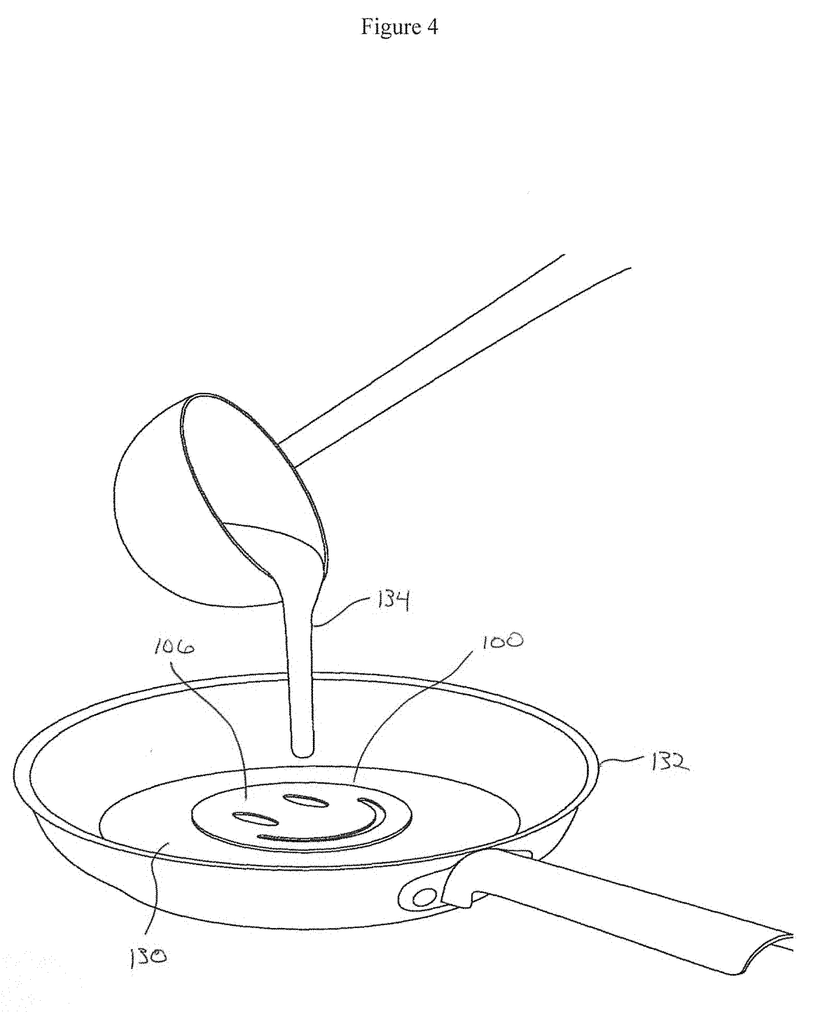

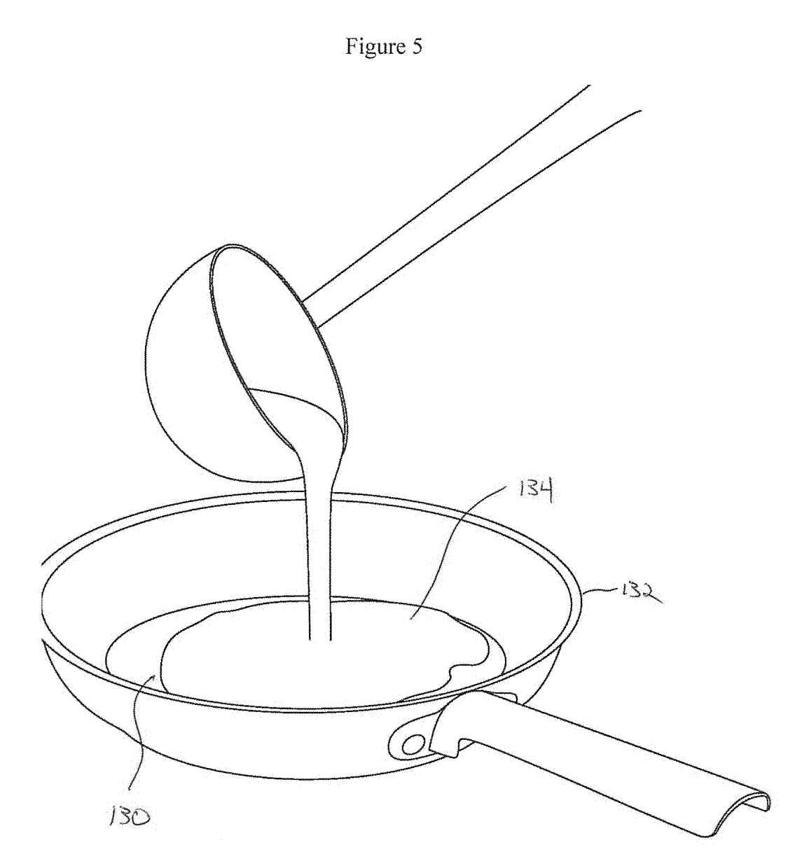

Referring now to FIGS. 4-7, a representative method of utilizing the stylizing member 100 is illustrated. As seen in FIG. 4, stylizing member 100 can be placed upon a cooking surface 130 of a cooking implement 132 with the lower surface 108 in direct contact with the cooking surface 130. As illustrated, the cooking implement 132 can include a frying pan or alternatively, an electric griddle or even a glass cooktop that can be used for cooking pancakes or similar food items. A liquid batter 134 can be poured over upper surface 106 of the styling member 100, such that at least a portion of the stylizing member 100 is covered by the liquid batter 134 as the remainder of the liquid batter 134 flows onto the cooking surface 130 as shown in FIG. 5. The heat of the cooking surface 130 begins cooking the liquid batter 134, while the portion of the liquid batter 134 that is separated from the cooking surface 130 by the stylizing member 100 experiences less heat due to the heat resistant material 109 of the stylizing member 100, and thus lower heat conduction to that portion of the liquid batter 134. As the liquid batter 134 is cooked, a pancake 136 is formed. When a first side 138 of the pancake 136 is fully cooked, the pancake 136 can be removed from the cooking surface 130 of the cooking implement 132. The stylizing member 100 can be removed from the first side 138 of the pancake 136, or the stylizing member 100 can remain on the cooking implement 132 as the pancake 136 is removed if the heat resistant material 109 has non-stick properties. With the stylizing member 100 removed from the first side 138, the visual element 120 defined by the stylizing member 100 including any imprint 140 defined within the first side 138 is visible. Visual element 120 is generally distinguished by having a lighter appearance (less browning) than the surrounding portions of the pancake 136 that were in direct contact with the cooking surface 130 as seen in FIGS. 7a, 7b and 7c. In the event that the stylizing member 100 includes apertures 116 and/or inserts 118, additional color variations (or level of browning) will be visible due to the amount of heat that was conducted to various portions of the pancake 136. For example, the eyes and mouth of the pancake 136 illustrated in FIG. 7B share the same darker brown appearance as the outer portions of the pancake 136 that were in direct contact with the cooking surface 130 due to the presence of eye apertures 116a and mouth aperture 116b. In some embodiments, the pancake 136 can be flipped upside down and positioned with a second side 140 at least partially covering the stylizing member 100 to similarly form the visual element 120 in the second side 140 as well.

Following use, stylizing member 100 can be cleaned and/or sanitized for reuse using conventional washing techniques. Generally, stylizing member 100 can be hand washed or placed in a dishwasher for cleaning. Following washing, the stylizing member 100 can be stored for reuse in the future.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

1. A foodstuff stylizing member, comprising:
a body having an upper surface, a lower surface and a perimeter wall defining a body shape, the body being formed of a heat-resistant material having a melting point exceeding about 500° F. such that either the upper surface or the lower surface can be positioned directly on a heated cooking surface, wherein the body is adapted for pouring a pourable batter over the body while positioned on the heated cooking surface so as to define a visual element in a cooked surface of a foodstuff.

2. The foodstuff stylizing member of claim 1, wherein the body includes at least one aperture extending between the upper surface and the lower surface to form part of the visual element.

3. The foodstuff stylizing member of claim 1, wherein the body includes at least one insert extending between the upper surface and the lower surface, the at least one insert formed of a different material than the body.

4. The foodstuff stylizing member of claim 1, wherein the heat-resistant material comprises a non-stick material.

5. The foodstuff stylizing member of claim 1, wherein the heat resistant material comprises silicone rubber or PTFE.

6. The foodstuff stylizing member of claim 1, wherein the heat resistant material comprises a heat resistant fabric having a non-stick coating.

7. The foodstuff stylizing member of claim 1, wherein the visual element is defined by varying levels of browning present in the cooked surface of the foodstuff.

8. A stylizing pancake formed with the foodstuff stylizing member of claim 1.

9. A method for stylizing foodstuff, comprising:
placing a foodstuff stylizing member directly on a cooking surface;
positioning an uncooked foodstuff on the cooking surface such that at least a portion of the foodstuff stylizing member is covered by the uncooked foodstuff;
cooking the uncooked foodstuff whereby the foodstuff stylizing member prevents a portion of the uncooked foodstuff from being in direct contact with the cooking surface;
removing a cooked foodstuff from the cooking surface, whereby at least one surface of the cooked foodstuff has a visual element defined therein, the visual element corresponding to the foodstuff stylizing member.

10. The method of claim 9, wherein the uncooked foodstuff comprises a pancake batter and wherein the cooked foodstuff comprises a pancake.

11. The method of claim 10, wherein the step of positing the uncooked foodstuff on the cooking surface further comprises:
pouring the pancake batter over the foodstuff stylizing member.

12. The method of claim 11, further comprising:
removing the foodstuff stylizing member from a cooked surface of the pancake, wherein the visual element is displayed on the cooked surface.

13. The method of claim 12, wherein the visual element comprises an imprint formed by a wall thickness of the foodstuff stylizing member.

14. The method of claim 12, further comprising:
flipping the pancake to place a second uncooked surface of the pancake on top of the foodstuff stylizing member.

15. The method of claim 9, further comprising:
forming the foodstuff stylizing member to include one or more apertures extending between an upper surface and a lower surface of the foodstuff stylizing member.

16. The method of claim 9, further comprising:
forming the foodstuff stylizing member to include one or more inserts extending between an upper surface and a lower surface of the foodstuff stylizing member, wherein the one or more inserts are formed of different materials than the foodstuff stylizing member.
